(19) United States
(12) Patent Application Publication
(10) Pub. No.: US 2013/0284825 A1
(43) Pub. Date: Oct. 31, 2013

(54) FUEL NOZZLE

(71) Applicants: Christopher Michael Prue, Simpsonville, SC (US); Thomas Edward Johnson, Greer, SC (US); Stephen Gerard Pope, Roebuck, SC (US)

(72) Inventors: Christopher Michael Prue, Simpsonville, SC (US); Thomas Edward Johnson, Greer, SC (US); Stephen Gerard Pope, Roebuck, SC (US)

(73) Assignee: GENERAL ELECTRIC COMPANY, Schenectady, NY (US)

(21) Appl. No.: 13/459,483

(22) Filed: Apr. 30, 2012

(51) Int. Cl. F02M 63/00

(52) U.S. Cl. 239/533.2

(57) ABSTRACT

A fuel nozzle includes a center body and a shroud circumferentially surrounding at least a portion of the center body to define an annular passage between the center body and the shroud. A plurality of vanes extend radially between the center body and the shroud in the annular passage. A first ceramic extension extends downstream from the shroud to define at least a portion of the annular passage downstream from the shroud.

### FIELD OF THE INVENTION

The present invention generally involves a fuel nozzle, such as may be incorporated into, for example, a combustor.

### BACKGROUND OF THE INVENTION

Combustors are known in the art for igniting fuel with air to produce combustion gases having a high temperature and pressure. For example, gas turbine systems, aircraft engines, and numerous other combustion-based systems include one or more combustors that mix a working fluid, such as air, with fuel and ignite the mixture to produce high temperature and pressure combustion gases. Each combustor generally includes one or more fuel nozzles that mix the working fluid with the fuel prior to combustion.

During normal combustor operations, a combustion flame exists downstream from the fuel nozzles, typically in a combustion chamber at the exit of the fuel nozzles. It is widely known that the thermodynamic efficiency of a combustion-based system generally increases as the operating temperature, namely the combustion gas temperature, increases. At higher combustion gas temperatures, however, an event referred to as “flame holding” may occur in which the combustion flame migrates upstream from the combustion chamber inside the fuel nozzles. For example, conditions may exist in which the combustion flame migrates upstream near a fuel port in the fuel nozzles or near an area of low flow in the fuel nozzles. The fuel nozzles are typically not designed to withstand the high temperatures created by flame holding, and flame holding may therefore cause undesirable wear to a fuel nozzle in a relatively short amount of time. Once worn, the combustor must be shut down to allow for partial or full repair/replacement of the fuel nozzle, resulting in unplanned and/or prolonged outages.

Various methods are known in the art for preventing or reducing the occurrence of flame holding. For example, flame holding is more likely to occur during the use of higher reactivity fuels or during the use of higher fuel-to-working-fluid ratios. Flame holding is also more likely to occur during operations in which the fuel-working fluid mixture flows through the fuel nozzles at lower velocities. Combustors may therefore be designed with specific safety margins for fuel reactivity, fuel-to-working-fluid ratios, and/or fuel-working fluid mixture velocities to prevent or reduce the occurrence of flame holding. While the safety margins are effective at preventing or reducing the occurrence of flame holding, they may also result in reduced operating limits, additional maintenance, reduced operating lifetimes, and/or reduced overall thermodynamic efficiency. Therefore, a fuel nozzle that may be more resistant to the effects of flame holding would be desirable.

### BRIEF DESCRIPTION OF THE INVENTION

Aspects and advantages of the invention are set forth below in the following description, or may be obvious from the description, or may be learned through practice of the invention.

One embodiment of the present invention is a fuel nozzle that includes a center body and a shroud circumferentially surrounding at least a portion of the center body to define an annular passage between the center body and the shroud. A plurality of vanes extend radially between the center body and the shroud in the annular passage. A first ceramic extension extends downstream from the shroud to define at least a portion of the annular passage downstream from the shroud.

Another embodiment of the present invention is a fuel nozzle that includes a center body and a shroud circumferentially surrounding at least a portion of the center body to define an annular passage between the center body and the shroud. A plurality of vanes extend radially between the center body and the shroud in the annular passage. A second ceramic extension extends downstream from the center body.

In a still further embodiment of the present invention, a fuel nozzle includes a center body and a shroud circumferentially surrounding at least a portion of the center body to define an annular passage between the center body and the shroud. A plurality of vanes extend radially between the center body and the shroud in the annular passage. A first ceramic extension extends downstream from the shroud to define at least a portion of the annular passage downstream from the shroud. A brazed connection is between the first ceramic extension and the shroud. A second ceramic extension extends downstream from the center body.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section of a combustor according to one embodiment of the present invention;

FIG. 2 is a side cross-section view of a fuel nozzle according to one embodiment of the present invention;

FIG. 3 is an enlarged view of a portion of the fuel nozzle shown in FIG. 2 according to a first embodiment of the present invention;

FIG. 4 is an enlarged view of a portion of the fuel nozzle shown in FIG. 2 according to a second embodiment of the present invention; and

FIG. 5 is an enlarged view of a portion of the fuel nozzle shown in FIG. 2 according to a third embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a fuel nozzle for use, for example, in a combustor. The fuel nozzle generally includes a center body, a shroud that circumferentially surrounds at least a portion of the center body to define an annular passage between the center body and the shroud, and a plurality of vanes that extend radially between the center body and the shroud in the annular passage. The center body, shroud, vanes, and annular passage enhance mixing between fuel, diluents, and/or other additives prior to reaching a combustion chamber downstream from the fuel nozzle. In particular embodiments, the fuel nozzle may further include one or more ceramic extensions downstream from the shroud and/or center body that increase the useful life and/or strength of the fuel nozzle. The ceramic extensions provide additional thermal resistance in the event flame holding were to occur and generally enhance the wear characteristics of the fuel nozzles during normal operations. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

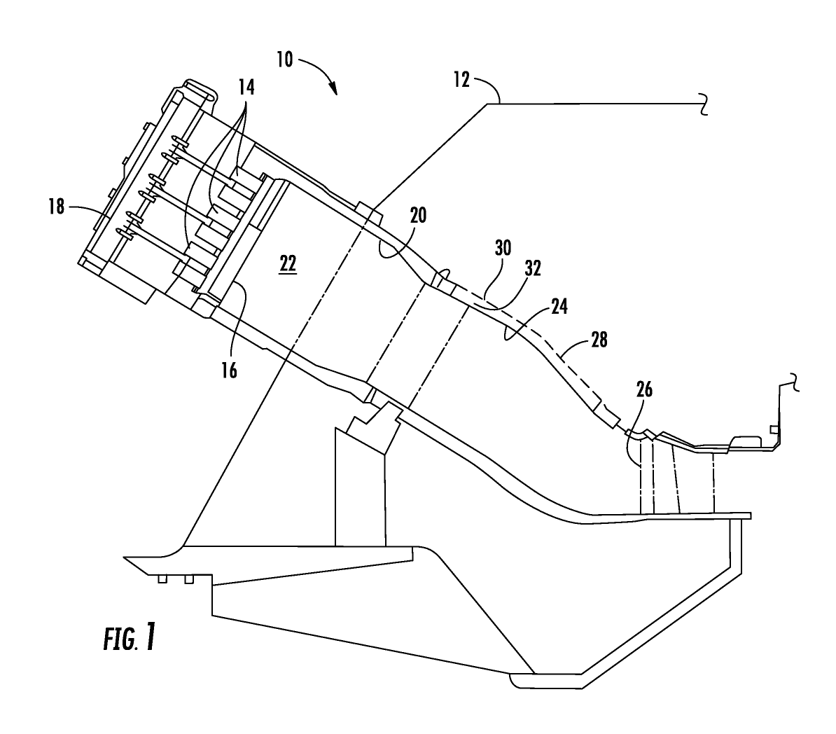

FIG. 1 shows a simplified cross-section view of an exemplary combustor 10, such as would be included in a gas turbine, according to one embodiment of the present invention. A casing 12 may surround the combustor 10 to contain a working fluid flowing to the combustor 10. One or more fuel nozzles 14 may be radially arranged between an end cap 16 and an end cover 18. A liner 20 downstream from the fuel nozzles 14 may combine with the end cap 16 to at least partially surround and/or define a combustion chamber 22 downstream from the fuel nozzles 14.

A transition piece 24 downstream from the liner 20 connects the combustion chamber 22 to a turbine inlet 26. An impingement sleeve 28 with flow holes 30 may surround the transition piece 24 to define an annular passage 32 between the impingement sleeve 28 and the transition piece 24. The compressed working fluid may pass through the flow holes 30 in the impingement sleeve 28 to flow through the annular passage 32 and provide convective cooling to the transition piece 24 and liner 20. When the compressed working fluid reaches the end cover 18, the compressed working fluid reverses direction to flow through one or more of the fuel nozzles 14 where it mixes with fuel before igniting in the combustion chamber 22 to produce combustion gases having a high temperature and pressure.

FIG. 2 provides a side cross-section view of the fuel nozzle 14 according to one embodiment of the present invention. As shown in FIG. 2, the fuel nozzle 14 generally includes a center body 40, a shroud 42, and a plurality of vanes 44. The center body 40 may be attached to the end cover 18 and generally extends downstream from the end cover to define an axial centerline 46 of the fuel nozzle 14. One or more passages in the center body 40 may provide fluid communication through the center body 40 so that fuel, diluents, and/or other additives may be supplied through the end cover 18 and center body 40 to the fuel nozzle 14. For example, as shown in FIG. 2, a plenum 48 in the center body 40 may provide fluid communication for fuel, diluents, and/or other additives to flow through end cover 18 and into the fuel nozzle 14.

The shroud 42 circumferentially surrounds at least a portion of the center body 40 to define an annular passage 50 between the center body 40 and the shroud 42, and the vanes 44 may extend radially between the center body 40 and the shroud 42 in the annular passage 50. The vanes 44 may include an upstream edge 52 and a downstream edge 54 and may be curved or angled with respect to the axial centerline 46 to impart tangential velocity or swirl to fluids flowing through the annular passage 50. For example, in particular embodiments the vanes 44 may include one or more fuel ports 56 so that fuel supplied through the plenum 48 may flow out of the vanes 44 to mix with working fluid flowing through the annular passage 50. The diameter and angle of the fuel ports 56 combine to ensure that the fuel adequately penetrates into the annular passage 50 and to prevent the fuel from simply streaming along the center body 40, the shroud 42, and/or the vanes 44. In this manner, the fuel and working fluid may mix in the annular passage 50 before entering the combustion chamber 22 and combusting.

Operational experience, testing, and computational fluid dynamic calculations indicate that the annular passage 50 may create an environment conducive to flame holding. For example, the downstream edge 54 of the vanes 44 may produce low flow areas or flow separation areas conducive to flame holding. As a result, various embodiments of the present invention may include one or more ceramic extensions downstream from the shroud 42 and/or center body 40 to provide increased thermal and/or wear tolerance for the fuel nozzles 14. The ceramic extensions may be manufactured and/or machined to conform to the particular diameter and/or thickness of the shroud 42 and/or center body 40, thereby producing a substantially flat surface along the fuel nozzle 14. In particular embodiments, welding, brazing, and/or other mechanical devices may be used to connect the ceramic extensions to the shroud 42 and/or center body 40. If welded or brazed, the design of the weld or braze joint may ensure that the temperature-sensitive portion of the joint will not be exposed to the higher temperatures that may exist inside the annular passage 50 to protect the integrity of the joint. For example, the sensitive portion of the joint may be located on a surface of the ceramic extension, shroud 42, and/or center body 40 that is not exposed to the higher temperatures associated with the annular passage 50.

In the particular embodiment shown in FIG. 2, the fuel nozzle 14 includes a first ceramic extension 60 that extends downstream from the shroud 42 and a second ceramic extension 62 that extends downstream from the center body 40. The first ceramic extension 60 may have a similar size and shape as the shroud 42 and at least partially define the annular passage 50 downstream from the shroud 42. Similarly, the second ceramic extension 62 may conform in size and shape to the center body 40 and may include the plenum 48 defined therein to provide fluid communication through the second ceramic extension 62. The ceramic extensions 60, 62 may connect to the respective shroud 42 and/or center body 40 proximate to the downstream edge 54 of the vanes 44. In this manner, the ceramic extensions 60, 62 may provide the desired thermal characteristics in the fuel nozzle 14 at a location that may be susceptible to flame holding. However, one of ordinary skill in the art will readily appreciate from the teachings herein that embodiments of the present invention are not limited to a particular connection point for the ceramic extensions 60, 62 unless specifically recited in the claims.

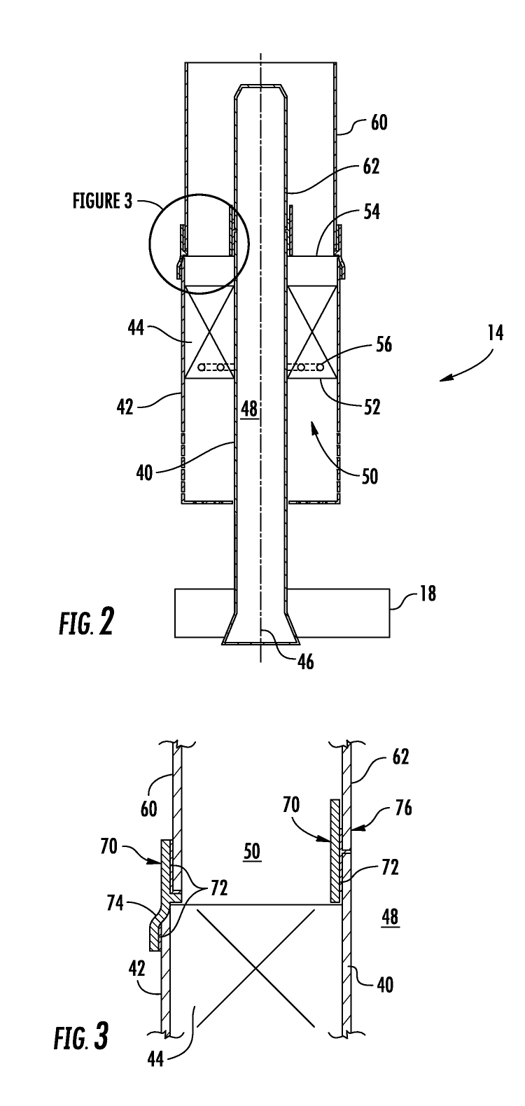

FIG. 3 provides an enlarged view of a portion of the fuel nozzle 14 shown in FIG. 2 to more clearly illustrate the connections with the ceramic extensions 60, 62 according to a first embodiment of the present invention. As shown, the fuel nozzle 14 may include a connector 70 that joins the ceramic extensions 60, 62 to the respective shroud 42 and/or center body 40. The connector 70 may include a threaded engagement or other mechanical device for attaching or joining the ceramic extensions 60, 62 to the respective shroud 42 and/or center body 40. Alternately, as shown in FIG. 3, the connector 70 may be manufactured from a suitable alloy that allows the ceramic extensions 60, 62 to be welded or brazed to the respective metallic shroud 42 and/or center body 40. For example, the connector 70 may include an alloy of iron, nickel, and cobalt to provide a suitable transition piece for welding or brazing the ceramic extensions 60, 62 to the respective shroud 42 and/or center body 40. Suitable braze materials 72 may include, for example, palladium, aluminum-silicon, copper, copper-silver, brass, and/or nickel alloys. To protect the integrity of the brazed connection between the ceramic extensions 60, 62 and the respective shroud 42 and/or center body 40, the connector 70 may be designed to allow the shroud 42, center body 40, and/or connector 70 to shield the braze material 72 from the temperatures associated with the annular passage 50. For example, as shown in the particular embodiment illustrated in FIG. 3, the braze material 72 between the shroud 42 and the connector 70 is not exposed to the annular passage 50, shielding the braze material 72 from the higher temperatures associated with the annular passage 50.

In the particular embodiment shown in FIG. 3, the connector 70 for the first ceramic extension 60 includes a radius 74. The radius 74 adapts the diameter of the first ceramic extension 60 to fit the shroud 42 having a slightly different diameter. As a result, the radius 74 of the less expensive connector 70 may be more easily adjusted as needed to allow the same ceramic extension 60 to fit multiple fuel nozzle 14 sizes. In contrast, the connector 70 for the second ceramic extension 62 does not include the radius 74. Instead, the connector 70 for the second ceramic extension 62 in the particular embodiment shown in FIG. 3 is generally straight and forms a full lap joint with both the second ceramic extension 62 and the center body 40, allowing the second ceramic extension 62 to abut the center body 40. As a result, the brazed connection between the second ceramic extension 62 and the center body 40 creates a substantially flat surface 76 inside the plenum 48 to reduce resistance to fluid flow inside the plenum 76.

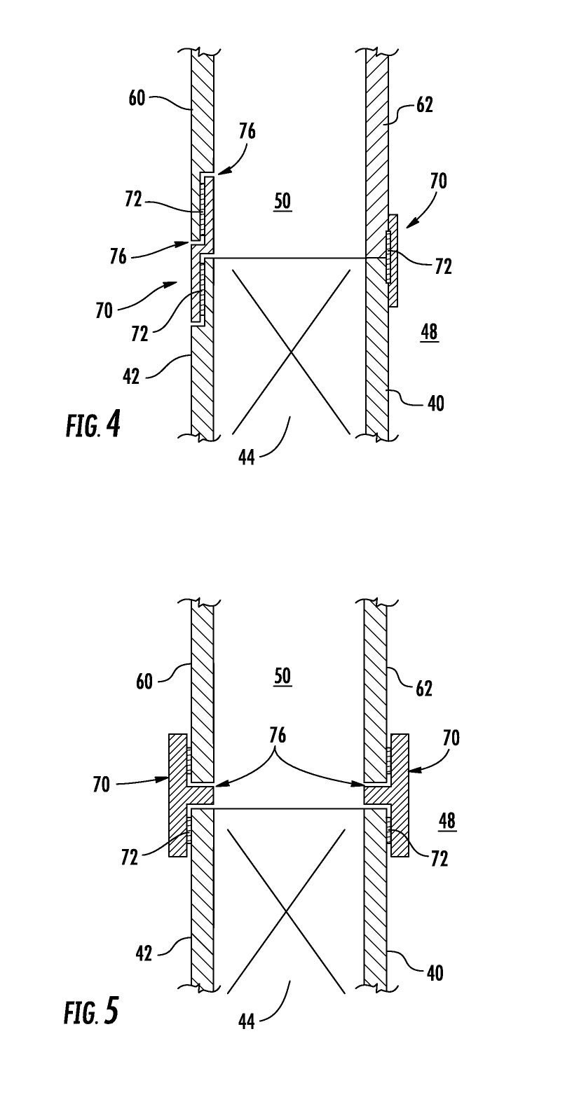

FIGS. 4 and 5 provide an enlarged views of a portion of the fuel nozzle 14 shown in FIG. 2 according to still further embodiments of the present invention. As shown in FIG. 4, the connector 70 for the first ceramic extension 60 forms a half-lap joint with both the first ceramic extension 60 and the shroud 42. As a result, the brazed connection between the first ceramic extension 60 and the shroud 42 creates a substantially flat surface 76 both inside and outside of the annular passage 50. In addition, the half-lap joints allow the first ceramic extension 60, shroud 42, and/or connector 70 to shield the braze material 72 from the temperatures associated with the annular passage 50 to protect the integrity of the brazed connection. In the particular embodiment shown in FIG. 5, the connectors 70 for the first and second ceramic extensions 60, 62 are T-shaped and located primarily outside of the annular passage 50. In this manner, the brazed connections provide substantially flat surfaces inside the annular passage 50 while also enhancing protection of the braze material 72 from the high temperatures associated with the annular passage 50. One of ordinary skill in the art will readily appreciate that many possible design combinations exist for the connectors 70, and the various embodiments of the present invention are not limited to any particular design or location for the connectors 70 unless specifically recited in the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fuel nozzle, comprising:
a. a center body;
b. a shroud circumferentially surrounding at least a portion of the center body to define an annular passage between the center body and the shroud;
c. a plurality of vanes that extend radially between the center body and the shroud in the annular passage; and
d. a first ceramic extension extending downstream from the shroud to define at least a portion of the annular passage downstream from the shroud.

2. The fuel nozzle as in claim 1, further comprising a connector between the shroud and the first ceramic extension.

3. The fuel nozzle as in claim 2, wherein the connector includes a radius between the shroud and the first ceramic extension.

4. The fuel nozzle as in claim 2, further comprising a substantially flat surface formed by the shroud, the first ceramic extension, and the connector inside the annular passage.

5. The fuel nozzle as in claim 2, further comprising a substantially flat surface formed by the shroud, the first ceramic extension, and the connector outside of the annular passage.

6. The fuel nozzle as in claim 2, further comprising a braze material between the first ceramic extension and the connector not exposed to the annular passage.

7. The fuel nozzle as in claim 2, further comprising a braze material between the shroud and the connector not exposed to the annular passage.

8. The fuel nozzle as in claim 1, further comprising a second ceramic extension extending downstream from the center body.

9. The fuel nozzle as in claim 8, further comprising a brazed connection between the center body and the second ceramic extension.

10. A fuel nozzle, comprising:
a. a center body;
b. a shroud circumferentially surrounding at least a portion of the center body to define an annular passage between the center body and the shroud;
c. a plurality of vanes that extend radially between the center body and the shroud in the annular passage; and
d. a second ceramic extension extending downstream from the center body.

11. The fuel nozzle as in claim 10, further comprising a brazed connection between the second ceramic extension and the center body not exposed to the annular passage.

12. The fuel nozzle as in claim 11, further comprising a substantially flat surface formed by the center body, the second ceramic extension, and the brazed connection inside the annular passage.

13. The fuel nozzle as in claim 10, further comprising a first ceramic extension extending downstream from the shroud to define the annular passage downstream from the shroud and a connector between the shroud and the first ceramic extension.

14. The fuel nozzle as in claim 13, wherein the connector includes a radius between the shroud and the first ceramic extension.

15. The fuel nozzle as in claim 13, further comprising a substantially flat surface formed by the shroud, the first ceramic extension, and the connector inside the annular passage.

16. The fuel nozzle as in claim 13, further comprising a substantially flat surface formed by the shroud, the first ceramic extension, and the connector outside of the annular passage.

17. The fuel nozzle as in claim 13, further comprising a braze material between the first ceramic extension and the connector not exposed to the annular passage.

18. The fuel nozzle as in claim 13, further comprising a braze material between the shroud and the connector not exposed to the annular passage.

19. A fuel nozzle, comprising:
a. a center body;
b. a shroud circumferentially surrounding at least a portion of the center body to define an annular passage between the center body and the shroud;
c. a plurality of vanes that extend radially between the center body and the shroud in the annular passage;
d. a first ceramic extension extending downstream from the shroud to define at least a portion of the annular passage downstream from the shroud;
e. a brazed connection between the first ceramic extension and the shroud; and
f. a second ceramic extension extending downstream from the center body.

20. The fuel nozzle as in claim 19, further comprising a substantially flat surface formed by the shroud, the first ceramic extension, and the brazed connection inside the annular passage.
